(19) United States
(12) Patent Application Publication
(10) Pub. No.: US 2017/0132528 A1
(43) Pub. Date: May 11, 2017

(54) JOINT MODEL TRAINING

(71) Applicant: Microsoft Technology Licensing, LLC, Redmond, WA (US)

(72) Inventors: Ozlem Aslan, Edmonton (CA); Rich Caruana, Woodinville, WA (US); Matthew R. Richardson, Seattle, WA (US); Abdelrahman Mohamed, Redmond, WA (US); Matthai Philipose, Redmond, WA (US); Krzysztof Geras, Edinburgh (GB); Gregor Urban, Munich (DE); Shengjie Wang, Bellevue, WA (US)

(21) Appl. No.: 15/195,894

(22) Filed: Jun. 28, 2016

Related U.S. Application Data
(60) Provisional application No. 62/252,355, filed on Nov. 6, 2015.

(51) Int. Cl. G06N 99/00; G06N 7/00

(52) U.S. Cl. CPC G06N 99/005; G06N 7/005

(57) ABSTRACT

Multiple machine learning models can be jointly trained in parallel. An example process for jointly training multiple machine learning models includes providing a set of machine learning models that are to learn a respective task, the set of machine learning models including a first machine learning model and a second machine learning model. The process can initiate training of the first machine learning model to learn a task using training data. During the training of the first machine learning model, information can be passed between the first machine learning model and the second machine learning model. Such passing of information (or “transfer of knowledge”) between the machine learning models can be accomplished via the formulation, and optimization, of an objective function that comprises model parameters that are based on the multiple machine learning models in the set.

### CROSS REFERENCE TO RELATED APPLICATION

This patent application claims the benefit of U.S. Provisional Patent Application Ser. No. 62/252,355 filed Nov. 6, 2015, entitled “JOINT MODEL TRAINING”, which is hereby incorporated in its entirety by reference.

### BACKGROUND

Machine learning generally involves processing a set of examples (called “training data”) in order to train a machine learning model. A machine learning model, once trained, is a learned mechanism that can receive new data as input and estimate or predict a result as output. For example, a trained machine learning model can comprise a classifier that is tasked with classifying unknown input (e.g., an unknown image) as one of multiple class labels (e.g., labeling the image as a cat or a dog).

Often, the best performing machine learning models—in terms of the accuracy of the model's output—comprise ensembles of hundreds or thousands of base-level machine learning models. However, maintaining and using the best performing ensembles may not be feasible or suitable in particular situations. For example, because ensembles typically require a relatively large storage footprint and powerful processing resources to execute at runtime, they are not well suited for implementations where storage space and/or computational power is at a premium (such as with smart phones, wearables, hearing aids, etc.).

### SUMMARY

Described herein are techniques and systems for jointly training multiple machine learning models. The joint training techniques described herein can be used to “transform” a machine learning model from a first type to a second type that mimics the first type of machine learning model. In one illustrative example application, this can allow for model compression, where the second type of machine learning model that mimics the first type can, at the completion of the joint training, have a reduced size (in terms of storage footprint), allowing for more flexible use of the second type of machine learning model in implementations where storage space and/or computational power is at a premium without significant loss in accuracy of the second model's output.

The notion of “joint” training is used herein to describe techniques for training two or more machine learning models in parallel, wherein at least one of the machine learning models influences the training of the other machine learning model. Such “parallel” training of multiple machine learning models can be contrasted with “sequential” training of multiple machine learning models. In sequential training, a first machine learning model is fully trained prior to initiating the training of a second machine learning model. In sequential training, the second machine learning cannot influence the training of the first machine learning model. By contrast, the joint training techniques described herein allow at least one of the machine learning models to influence the training of another machine learning model as the multiple models are being trained. Temporally speaking, in “parallel” training, a first machine learning model is trained while a second machine learning model is training and/or before the second machine learning model completes its training.

In some implementations, a process for jointly training multiple machine learning models includes providing a set of machine learning models that are to learn a respective task, the set of machine learning models including a first machine learning model and a second machine learning model. The process can initiate training of the first machine learning model to learn a task using training data. During the training of the first machine learning model, information can be passed between the first machine learning model and the second machine learning model. Such passing of information (or “transfer of knowledge”) between the machine learning models allows for one machine learning model to influence the other while the multiple machine learning models are trained in parallel. The passing of information can be accomplished via the formulation, and optimization, of an objective function that comprises model parameters that are based on the multiple machine learning models in the set. In this manner, the second machine learning model can access information about the outputs of the first machine learning model based on the first model's processing of the training data as input prior to the first model completing its training.

In some implementations, a process can include generating an objective function that is to be used for jointly training a set of machine learning models. The objective function can include at least one term that is a function of: (i) a first output of a first machine learning model and (ii) a second output of a second machine learning model. The process can further include optimizing the objective function to train the first machine learning model and the second machine learning model in parallel. In some implementations, optimizing the objective function includes determining values of model parameters, such as weight parameters, that optimize the objective function.

The joint model training techniques described herein provide greater flexibility as compared to current model training methods due to the ability of at least one model to influence the training of at least one other model during the joint training process. In this sense, a machine learning model is able to see what another machine learning model is learning, as the other machine learning model is learning. Furthermore, multiple machine learning models can be trained in a collaborative fashion where visibility across models is enabled, which can lead to one machine learning model selecting a learning function that is best suited for another machine learning model. Machine learning models that are trained using the techniques described herein can perform better (in terms of the accuracy of the model output) than conventionally-trained machine learning models in some scenarios. Furthermore, the machine learning models that are trained with the techniques and systems described herein can be deployed or implemented in a more versatile fashion.

Moreover, the techniques and systems described herein improve the technical field of machine learning by providing more flexibility in model training, as compared to current training methods. For example, the techniques and systems described herein allow for “transforming” a machine learning model from one type to another type by training a particular type of machine learning model to mimic another type of machine learning model. In this scenario, two or more jointly trained models can, at the completion of joint training, differ in terms of the models' architecture, size (in terms of storage footprint), speed (in terms of operation at run-time), the learning function employed, and other model attributes, as described herein.

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicates similar or identical items.

FIG. 1 is a schematic diagram of an example technique for joint training of multiple machine learning models.

FIG. 2 is a schematic diagram of another example technique for joint training of multiple machine learning models.

FIG. 3 is a schematic diagram of another example technique for joint training of multiple machine learning models.

FIG. 4 is a schematic diagram of another example technique for joint training of multiple machine learning models.

FIG. 5 is a schematic diagram of another example technique for joint training of multiple machine learning models.

FIG. 6 is a flow diagram of an example process for joint training of multiple machine learning models.

FIG. 7 is a flow diagram of an example process of optimizing an objective function used for joint training of multiple machine learning models.

FIG. 8 illustrates an example environment for implementing the techniques and systems described herein.

### DETAILED DESCRIPTION

Described herein are techniques and systems for jointly training multiple machine learning models. Numerous applications for the use of joint training are contemplated herein. Although many examples provided herein are discussed in terms of using joint training for model compression (i.e., training a relatively compact model (in terms of storage footprint) in parallel with a larger, more complex model to approximate the function learned by the complex model), the techniques and systems described herein are not limited to model compression. For example, two machine learning models of the same, or similar, size can be jointly trained, wherein the two machine learning models differ in terms of their architectures or some other model attribute. The word “model” can be used throughout the disclosure as an abbreviated form of “machine learning model.”

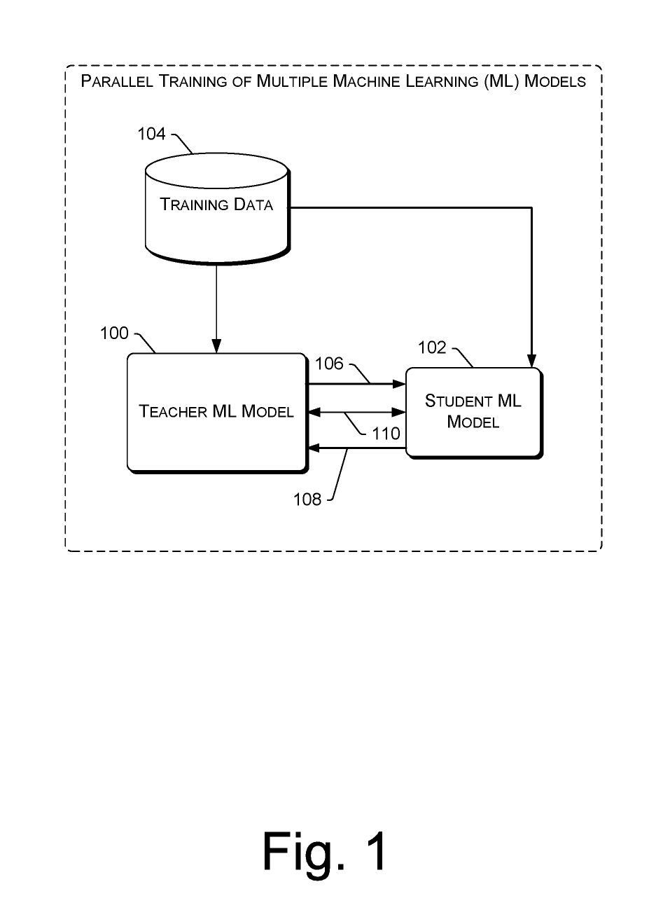

FIG. 1 is a schematic diagram of an example technique for jointly training multiple machine learning models. FIG. 1 illustrates a first machine learning model 100 and a second machine learning model 102 that make up a set of machine learning models that are to be trained in parallel, according to the techniques and systems described herein. In FIG. 1, the first machine learning model 100 is denoted as a “teacher machine learning model” or “teacher model,” and the second machine learning model 102 is denoted as a “student machine learning model” or “student model.” Calling the first model 100 a “teacher model” and the second model 102 a “student model” is somewhat arbitrary because either model can be capable of learning from the other. The notion of a “teacher model” is one where the teacher influences the training of the student (i.e., the student learns, at least partly, from the teacher).

The machine learning models 100 and 102, and any of the machine learning models discussed herein, can be implemented as any type of machine learning model. For example, suitable machine learning models for use with the techniques and systems described herein include, without limitation, tree-based models, support vector machines (SVMs), kernel methods, neural networks, random forests, splines (e.g., multivariate adaptive regression splines), hidden Markov model (HMMs), Kalman filters (or enhanced Kalman filters), Bayesian networks (or Bayesian belief networks), expectation maximization, genetic algorithms, linear regression algorithms, nonlinear regression algorithms, logistic regression-based classification models, or an ensemble thereof. An “ensemble” can comprise a collection of models whose outputs (predictions) are combined, such as by using weighted averaging or voting. The individual machine learning models of an ensemble can differ in their expertise, and the ensemble can operate as a committee of individual machine learning models that is collectively “smarter” than any individual machine learning model of the ensemble.

FIG. 1 further illustrates that training data 104 can be used to train at least one of the machine learning models 100 and/or 102. FIG. 1 shows that both machine learning models 100 and 102 can receive at least some of the training data 104, but this is merely shown for exemplary purposes. In some implementations, a single model, such as the first model 100, can receive the training data 104, while the second model 102 does not receive the training data 104. Thus, although FIG. 1 shows both models 100 and 102 as explicitly receiving, or having access to, the training data 104, it is to be appreciated that any individual machine learning model shown in the Figures and described herein can receive, or have access to, at least some of the training data 104 in particular implementations, even if an explicit connection between an individual model and the training data is not depicted in the Figures. In instances where a machine learning model, such as the second model 102, does not receive the training data 104 used by the first model 100, the second model 102 still has access to at least some features in order to communicate with the first model 100. For example, even if the second model 102 does not receive the training data 104, the second model 102 can still receive, or still has access to, some unlabeled data that is not in the training data 104. Such unlabeled data may comprise data that was not used by the first model 100, or, alternatively, the unlabeled data accessible to the second model 102 can be unlabeled data that the first model 100 uses to generate an output that is passed to the second model 102 for joint training. In this manner, information can be passed between the first model 100 and the second model 102 and the second model 102 can learn from the first model 100 as the second model 102 is trained. In some implementations, the second model 102 can access some data for joint training purposes, and the second model 102 can access other new data that is inaccessible to the first model 100 when the first model 100 is training, but accessible to the first model 100 when the first model 100 passes output to the second model 102. “Passing information,” in this sense, is described in more detail below.

The training data 104 can be stored in a database or repository of any suitable data, such as image data, speech data, text data, video data, or any other suitable type of data that can be processed by the machine learning models 100 and 102. For example, the training data 104 can comprise a repository of images that are to be classified or labeled by the machine learning models 100 and/or 102. The training data 104 can further include at least two additional components: features and labels. However, the training data 104 may be unlabeled in some implementations, such that the machine learning models 100 and/or 102 can be trained using any suitable learning technique, such as supervised learning, unsupervised learning, semi-supervised learning, reinforcement learning, and so on. The features included in the training data 104 can be represented by a set of features, such as in the form of an n-dimensional feature vector of quantifiable information about an attribute of the training data 104. For example, if the training data 104 comprises a repository of images, the feature vector can include values that correspond to the pixels of the image, the size (length, height, area, etc.) and/or shape of objects, color, hue, saturation, and/or intensity, and so on. For text-based training data 104, the feature vector can include values that correspond to term occurrence frequencies, or the like.

In some implementations, the first model 100 and the second model 102 can be trained in parallel so that each model learns a task. The task learned by the first model 100 can be the same task as the task learned by the second model 102, or each model 100 and 102 can learn related (or complimentary) tasks, meaning that the tasks can differ slightly between the models 100 and 102. For example, the first model 100 can be trained to infer a set of probabilities for a multi-label classification task based on unknown image data received as input, and the second model 100 can be trained to classify the unknown image data as one of multiple possible class labels, but does not infer a set of probabilities as output. The tasks are similar in that they relate to classifying unknown images by one of multiple class labels, but one model (the first model 100) outputs a set of probabilities as a prediction while the other model (the second model 102) outputs class labels. In general, the “task” can comprise a task to infer an expected output based at least in part on an unknown input. For example, the task can comprise a classification task, such as a binary classification task having two possible outputs (e.g., “yes” or “no”), or a multi-label classification task having more than two possible outputs (e.g., labeling images as “cat,” “dog,” “duck,” “penguin,” and so on). Additionally, or alternatively, the task can be to infer a set of probabilities based on unknown input data.

Joint training of the first model 100 and the second model 102 involves training the models 100 and 102 in parallel such that at least one of the models 100 and/or 102 influences the training of the other model. For example, the first model 100 can learn from the training data 104, and the training of the second model 102 can be influenced by what the first model 100 is learning from the training data 104 while the first model 100 is being trained, and/or before the first model 100 completes its training. In this sense, the second (student) model 102 can be considered to be learning from the first (teacher) model 100 as the first model 100 learns. The aforementioned scenario is depicted visually in FIG. 1 by the path 106 that goes from the training data 104 to the first model 100, and from the first model 100 to the second model 102.

Notably, this implementation of parallel training of the multiple models 100 and 102 can be contrasted with training of the models 100 and 102 sequentially. In sequential training, the first model 100 would be fully trained prior to training the second model 102, or vice versa. Instead, with the joint training technique of FIG. 1, the second model's 102 training can be influenced by the first model 100 (e.g., by the second model 102 having access to information about the outputs of the first model 100 based on the first model's 100 processing of the training data 104 as input) while the first model 100 is training, and/or prior to the first model 100 completing its training. One example benefit of this technique is that the second (student) model 102 can begin learning as soon as the first (teacher) model 100 begins learning. This also enables the second (student) model 102 to “see” the training data 104 (e.g., the original labels, assuming that the training data 104 is labeled), thus allowing the second (student) model 102 to initially learn the concepts that the first (teacher) model 100 learned first, and then to learn the more complex, harder concepts learned by the first (teacher) model 100 after the second model 102 has learned the simpler concepts. This form “curriculum learning” allows the second (student) model 102 to see the sequence of learning by the first (teacher) model 100 as opposed to seeing only the fully trained version of the first (teacher) model 100.

As described herein, a model, such as the second (student) model 102, is able to “see” what another model, such as the first (teacher) model 100, is learning by virtue of terms in the objective function that is optimized for training the respective models 100 and 102. Thus, many examples discussed herein describe “passing information” between machine learning models, which comprises formulating an objective function for the multiple machine learning models in a set of models so that each model can have access to unlabeled data, and/or the training data 104, and/or outputs generated by at least one other model through one or more terms of the objective function. In other words, the second (student) model 102, in the absence of seeing the training data 104, can see one or more features (without any labels) in order to “communicate” with the first model 100 via the objective function for purposes of joint training. In some implementations, the second (student) model 102 can see at least some of the features that the first (teacher) model 100 used to generate at least some observations so that the first and second models 100 and 102 can “communicate” with each other via the objective function for purposes of joint training. The objective function is described in more detail below.

In some implementations, the second model 102 is trained in parallel with the training of the first model 100 by providing some or all of the training data 104 to the second model 102, as depicted visually in FIG. 1 by the path 108 going from the training data 104 to the second model 102, and from the second model 102 to the first model 100. In this scenario, the first (teacher) model 100 can “see” what the second (student) model 102 is learning while the second model 102 trains, and/or before the second model 102 completes its training. This can allow the first (teacher) model 100 to adapt what it learns to better match what the second (student) model 102 is learning or is capable of learning. For example, the first (teacher) model 100 can be capable of using two different learning functions that result in the first model's 100 output being 90% accurate, but one of those learning functions is something that the second (student) model 102 is capable of using, while the student model 102 may not be capable of using the other learning function. Accordingly, the first (teacher) model 100 can be biased toward using the learning function that is “good” for the second (student) model 102. The biasing of the first model 100 toward something that is beneficial for the second model 102 can be implemented via a penalty (or distance) term in the objective function that causes the first model 100 to agree with the second model 100 as opposed to disagreeing with the second model 100. This will be discussed in more detail below.

In some implementations, the second (student) model 102 can receive a portion, but not all, of the training data 104, such as a subset of features in the training data 104 that are relatively easy or fast to compute. For instance, the first (teacher) model 100 can be trained by processing a 100-dimensional feature vector from the training data 104, and the second (student) model 102 can be trained in parallel by processing a 10-dimensional feature vector that has fewer dimensions than the feature vector processed by the first (teacher) model 100.

So far, two possible directions for transferring knowledge (or passing information) between the multiple models 100 and 102 during joint training have been discussed with reference to paths 106 and 108 of FIG. 1. Additionally, knowledge can be bi-directionally transferred between the first model 100 and the second model 102 during joint training, as depicted visually in FIG. 1 by path 110 between the first model 100 and the second model 102. In other words, data can be processed by each model 100 and 102, and the objective function used for joint training of the models 100 and 102 can determine the degree to which the models 100 and 102 agree with each other, and can “push” the models toward agreement. For example, in the scenario of a multi-class labeling task for image data, each model 100 and 102 can process an unlabeled (or unknown) image to compute a set of probabilities for that image that indicate the probabilities of the image being in each of multiple (e.g., 100) possible classes. In this example, the first model 100 can predict that the image is: a dog with 0.9 (90%) probability, a duck with 0.8 probability, a cat with 0.2 probability, and so on for n-class labels. Meanwhile, the second model 100 can predict a set of probabilities for the same image. The objective function used for joint training of the models 100 and 102 can include a penalty term (sometimes called a “distance term”) that optimizes the objective function when the probabilities that are output by the first model 100 are similar to, or the same as, the probabilities output by the second model 102. In this manner, the penalty term of the objective function can quantifiably measure the agreement/disagreement between the probabilities of the two models 100 and 102, and works by penalizing the optimization problem when the probabilities disagree, which acts to push the two models 100 and 102 toward agreement with each other. In some implementations, the objective function is designed to push one model toward the other (e.g., pushing the second model 102 to agree with the first model 100, or vice versa).

In the implementation where the two models 100 and 102 collaborate with each other during joint training (shown via the path 110 in FIG. 1), the models 100 and 102 can process any suitable unlabeled data. For example, a billion unknown images can be downloaded from a database of images on the Web, or, alternatively, the training data 104 can be utilized by “throwing away” labels, if necessary, and processing the unlabeled training data 104. The objective function used for joint training can be formulated in a way to effectively allow the two models 100 and 102 to collaborate and discuss their respective predictions with each other (via the path 110) to help each model learn how the other model thinks, which factors into its own training. For instance, the first model 100 can predict that an unknown image is a cat with 0.9 probability, while the second model 102 predicts that the same unknown image is a cat with 0.6 probability and a dog with 0.3 probability. This information can be passed between the models 100 and 102 via the path 110 during joint training by virtue of terms included in the objective function for both models.

In some implementations, an optimization problem can be solved during joint training by optimizing an objective function jointly with respect to weight parameters of multiple models being trained in parallel, such as during joint training of the first model 100 and the second model 102 shown in FIG. 1. Let Lₜₑ and Lₛₜ represent classification losses for the first (teacher) model 100 and the second (student) model 102, respectively. Let Rₜₑ and Rₛₜ represent regularization terms for the first (teacher) model 100 and the second (student) model 102, respectively. As noted with reference to the path 110 of FIG. 1, the objective function can account for, and penalize, the difference between the outputs of the first (teacher) model 100 and the second (student) model 102 when unlabeled data is passed through both models so as to urge or “push” the multiple models toward agreement with each other (or to push one model towards agreement with the other). In order to accomplish this biasing toward model output agreement in the objective function, a penalty term can be defined, such as the following Bregman divergence distance function between the outputs of the first (teacher) model 100 and the second (student) model 102:

D_{F}(ψ^{(te)},ψ^{(st)})=F(ψ^{(te)})−F(ψ^{(st)})−∇F(ψ^{(st)})′(ψ^{(te)}−ψ^{(st)}) (1)

Here, F can be a differentiable and strictly convex function. ψ^{(te)} and ψ^{(st)} can be the outputs of the first (teacher) model 100 and the second (student) model 102, respectively. The outputs (ψ^{(te)} and ψ^{(st)}) of the models 100 and 102 can comprise any suitable output from the respective models 100 and 102. In some implementations, the outputs (ψ^{(te)} and ψ^{(st)}) can comprise a set of probabilities, such as probabilities computed using a softmax function

$${p}_{k} = \frac{{exp}^{{z}_{k}}}{{Σ}_{j} {exp}^{{z}_{j}}} ,$$

where zε [symbol] ^{c} denotes logits (also called “log probability values”), which comprise logarithms of predicted probabilities output by the model in question. In some implementations, the outputs (ψ^{(te)} and ψ^{(st)}) can comprise logits (z^{te} and z^{st}) generated by the multiple models 100 and 102. In some implementations, the outputs (ψ^{(te)} and ψ^{(st)}) can comprise unnormalized probabilities. In fact, the outputs (ψ^{(te)} and ψ^{(st)}) can comprise any value from an intermediate stage in the models 100 and 102. For example, if the model 100 represents a neural net, the output ψ^{(te)} can comprise a value generated a number of layers back from (prior to) the final neural net output.

With the penalty term defined, the objective function for joint training of the first and second models 100 and 102 can be generated as follows:

Lₜₑ(Φ^{(te)},Y)+αₜₑRₜₑ( [symbol] ₜₑ)+γ₁(Lₛₜ(Φ^{(st)},Y)+αₛₜRₛₜ( [symbol] ₛₜ))+γ₂D_{F}(ψ^{(te)},ψ^{(st)}) (2)

In the objective function (2), Φ^{(te)} and Φ^{(st)} are matrices used for the classification terms of the objective function (2) with row-wise stacked outputs of the first (teacher) model 100 and the second (student) model 102, respectively. Again, the outputs in the matrices Φ^{(te)} and Φ^{(st)} can comprise probability outputs, such as probabilities computed using the softmax function, logits (z^{te} and z^{st}), or any other suitable outputs from the models 100 and 102. ψ(te) and ψ(st) can comprise matrices used for the penalty term (or distance term) with row-wise stacked outputs (e.g., probabilities, logits, etc.) of the first (teacher) model 100 and the second (student) model 102, respectively. As noted above, Lₜₑ and Lₛₜ can comprise losses for the first (teacher) model 100 and the second (student) model 102, respectively. For example, the losses Lₜₑ and Lₛₜ can comprise cross entropy losses, squared losses, large margin losses, and the like. [symbol] ₜₑ and [symbol] ₛₜ can comprise a set of weights of the layers of the first (teacher) model 100 and the second (student) model 102, respectively. Rₜₑ and Rₛₜ can comprise regularization terms for the first (teacher) model 100 and the second (student) model 102, respectively. For example, the regularization terms Rₜₑ and Rₛₜ can comprise L₁ or L₂ norms that are a summation over regularization of each weight matrix of the layers of the first (teacher) model 100 and the second (student) model 102, respectively. αₜₑ and αₛₜ can comprise regularization coefficients, and γ₁≧0 and γ₂≧0 can comprise coefficients that are tunable during training of the models 100 and 102. Y represents the original labels from the training data 104 when the training data 104 comprises labeled training data 104.

Use of the Bregman divergence in the penalty term, shown by Equation (1) and used in the objective function (2), allows defining different distances for the penalty term, such as squared distance, Kullback-Leibler divergence (“KL divergence”), Itakura-Saito distance, and the like. In the implementation where ψ^{(te)} and ψ^{(st)} comprise logits, F in Equation (1) can be defined as F(x)=∥x∥₂², which results in squared distance ∥ψ^{(te)}−ψ^{(st)}∥₂². Alternatively, where ψ^{(te)} and ψ^{(st)} comprise probabilities (e.g., outputs of the softmax function), F in Equation (1) can be defined as F(p)=Σᵢpᵢ log(pᵢ), which results in the following KL divergence:

$${D}_{KL} ( {p}^{( te )} \vert \vert {p}^{( st )} ) = {Σ}_{i} {p}_{i}^{( te )} log ( \frac{{p}_{i}^{( te )}}{{p}_{i}^{( st )}} ) \qquad ( 3 )$$

The KL divergence of Equation (3) is not symmetric, so the symmetrized divergence can be formulated as:

D_{F}^{sym}(p^{(te)}∥p^{(st)})=½(D_{KL}(p^{(te)}∥p^{(st)})+D_{KL}(p^{(st)}∥p^{(te)})) (4)

The joint training of multiple machine learning models, such as the first model 100 and the second model 102 of FIG. 1, through use of the objective function (2) enables the second model 102 to see the training data 104 (e.g., the original labels) via the classification term Lₛₜ(Φ^{(st)},Y). Contrast this objective function (2) with sequential training where the first (teacher) model 100 is trained first, and then the second (student) model 102 is trained after, wherein the second (student) model 102 would not be influenced by the original training data 104. Also note that if γ₁=0, and the penalty term comprises squared distance, a joint optimization model can be defined where the first (teacher) model 100 is trained using the training data 104, and the second (student) model 102 is trained from the output of the first (teacher) model 100 during the training of the first (teacher) model 102, as depicted visually by path 106 in FIG. 1. In this instance, both models 100 and 102 can see at least some data features for passing information between the models 100 and 102 via the objective function, but the second model 102, for example, does not see the original labels of the training data 104.

To extend the joint training techniques of FIG. 1 to a semi-supervised learning implementation, unlabeled data, Xᵤₙε [symbol] ^{T}^{ᵤ}^{×d}, can be used in the objective function (2) through a change to the input data as follows:

X_{cl}=[X;0ₓ]

Y_{cl}=[Y;0_{y}]

X_{dist}=[X;Xᵤₙ] (5)

Here, 0ₓ comprises the Tᵤ×d zero matrix, and 0_{y} comprises the Tᵤ×c zero matrix. Furthermore, X_{cl} and Y_{cl} can be used in the classification terms of the objective function (2), and X_{dist} can be used in the penalty term (or distance term) of the objective function (2).

Joint compression can be computationally expensive due to the weight parameters of more than one machine learning model that are jointly optimized. This is especially true in instances where one or more of the machine learning models, such as the first (teacher) model 100, comprises a deep machine learning model with a relatively high number of parameters and/or hyper-parameters to be tuned, such as learning rate, dropout, initialization, momentum, gamma, weight decay coefficient, optimization coefficient, and so on, for each machine learning model involved in the joint training. Accordingly efficient training procedures can be implemented to address the computational overhead involved with joint training of deep machine learning models. Optimization can be challenging in practice since it is not known how the stochastic gradient will behave for the joint optimization problem. The joint training procedure described herein can benefit from larger epochs and a different update procedure. Different learning rates and momentum can be used for the Nesterov algorithm.

In some implementations, an efficient joint training procedure can include scheduling updates of one or more of the models in a set of models being trained in parallel. For example, a scheduling module can initiate training of the second (student) machine learning model 102 at a slow learning rate, and gradually increase the learning rate of the second model 102 as training progresses. In some implementations, the efficient joint training procedure can be initialized with a best performing machine learning model available. In general, a scheduling module can be configured to control the learning rate of any machine learning model for efficiency in computation. Furthermore, the scheduling module can be configured to control the degree to which any given machine learning model can influence another. For example, an allocation between the use of training data and machine learning model output can be specified for a given model's training (e.g., 90% training from training data 104, and 10% training from the output of another machine learning model).

The joint training techniques described herein can be used for various applications. One example application is model compression, which allows for compact representations of deep (i.e., many layers) machine learning models that generally are allocated a large amount of memory to maintain, are complex in architecture, and use a high amount of processing power to operate at runtime. For example, the first (teacher) model 100 of FIG. 1 can comprise a large, complex ensemble of machine learning models that is often too large and/or slow to be used at run-time in particular scenarios. Meanwhile, the second (student) model 102 can comprise a much smaller machine learning model (e.g., a neural net with 1000 times fewer parameters than the first model 100) that has the size and/or speed that is advantageous at run-time in particular scenarios. By joint training the first and second models 100 and 102 using the techniques and systems described herein, the second model 102 can be trained to mimic the much larger first model 100 (through learning how to approximate the function learned by the first model 100) without significant loss in accuracy of the second model's 102 output. Because the smaller second model 102 take much less memory to maintain and can operate faster on less processing power at runtime, the second model 102 can be a compressed form of the larger first model 100 such that the second model 102 can be more readily deployed on computing devices with limited resources (e.g., mobile devices, wearables, etc.).

Notwithstanding the utility of the joint training techniques for use in model compression, it is to be appreciated that other applications for the use of joint training are contemplated where, more generally, one type of machine learning model can be “transformed” into another type of machine learning model. For instance, the first model 100 and the second model 102 can differ in their architectures—the first model 100 can comprise a deep neural net (DNN) and the second model 102 can comprise a boosted decision tree—with one having a computational advantage over the other in a given scenario. Perhaps the first DNN model 100 is best suited for accurately learning from the original training data 104, but it is not the type of model that is best to deploy in a particular scenario. Instead, the second model 102 that can be trained in parallel with the first model 100 according to the techniques and systems described herein can be easily deployable and can learn from information passed to it from the first model 100 via the terms of the objective function. Notably, the multiple models that are jointly trained can be of the same, or similar, size (in terms of storage footprint to store each model), yet the architecture can be optimized in at least one of the models for deployment purposes.

Additionally, or alternatively, the models involved in joint training according to the techniques and systems described herein can differ in: (i) the learning methods they employ during training, (ii) their respective speed of operation at runtime, (iii) their ability to be distributed across many different machines for use in parallel processing environments, or (iv) their “understandability” in that one model is in a language more comprehensible to humans than the other, and so on.

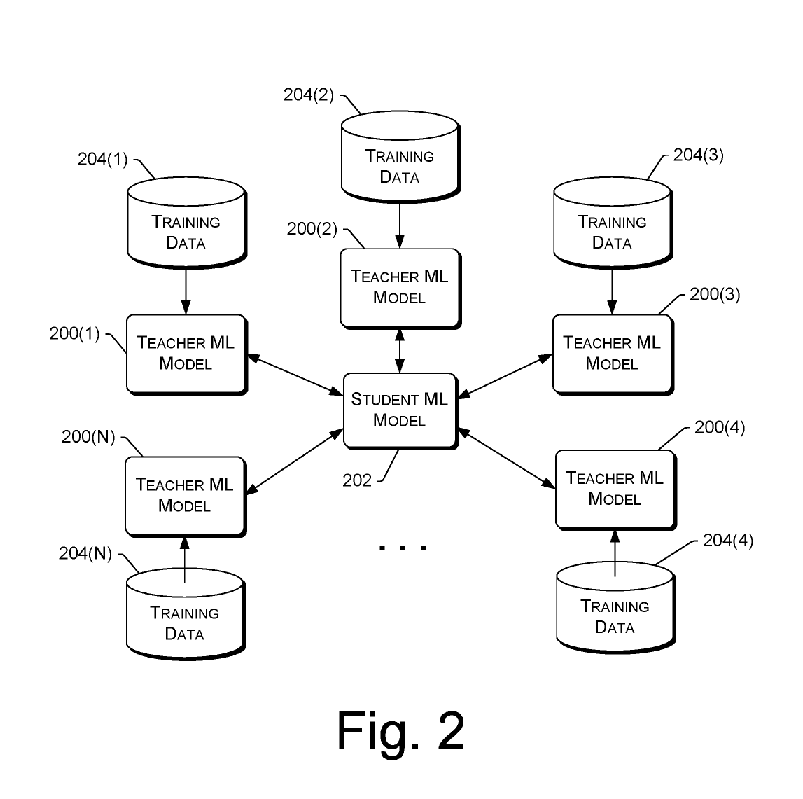

In some implementations, various ensembles of teacher models and/or ensembles of student models can be utilized with the joint training techniques and systems described herein. FIG. 2 is a schematic diagram of an example technique for joint training of multiple machine learning models involving an ensemble of N “teacher” models 200, represented in FIG. 2 as models 200(1), 200(2), . . . , 200(N). The N teacher models 200 can be of the same type and size, or can differ in type (i.e., architecture) and/or size. In the implementation of FIG. 2, the student model 202 is to be jointly trained in parallel with the N teacher models 200, where each model 200(1)-(N) and 202 is to learn substantially similar tasks. In this sense, each of the teacher models 200 can influence the training of the student model 202, and vice versa, during joint training. Each of the N teacher models 200 is also shown as receiving corresponding training data 204(1)-(N). The training data 204(1)-(N) can each comprise an independent source of training data, or the training data 204(1)-(N) can represent a single source of training data 204 that is used by the teacher models 200 for training.

To implement the example configuration of FIG. 2, the objective function (2) can be modified by averaging the outputs of the N teacher models 200 with a variable modification, such as the following variable modification:

$${Φ}^{( te )} = \frac{1}{N} {\sum }_{i = 1}^{N} {Φ}^{( {te}_{i} )} \\ {ψ}^{( te )} = \frac{1}{N} {\sum }_{i = 1}^{N} {ψ}^{( {te}_{i} )} \qquad ( 6 )$$

Here, the N teacher models 200 are indexed by {teᵢ}ᵢ₌₁^{N}. Additionally, Φ^{(te}^{ᵢ}⁾ comprises an output matrix used in the classification term of the teacher model teᵢ in the objective function (2). ψ^{(te}^{ᵢ}⁾ comprises an output matrix used in the penalty term (or distance term) for the teacher model teᵢ in the objective function (2). Using the variable modification in Equations (6) in the objective function (2) allows for determining values of model parameters of the ensemble of N teacher models 200 jointly rather than post-averaging after training each teacher model 200 separately.

In some implementations, the ensemble of N teachers 200 shown in FIG. 2 can be augmented to enable communication between pairs of the teacher models 200, as well as communication between the student model 202 and any one of the teacher models 200, using pairwise penalty terms (or distance terms) in the objective function (2) for the respective pairs of models that communicate with each other. Furthermore, the student model 202 can “see” the original training data 204 via a classification term in the objective function (2). This enables joint training where each pairing of the student model 202 with a teacher model 200 can be pushed toward agreement with each other during joint training of the models 200 and 202 using penalty terms (or distance terms) of the objective function (2). For instance, each teacher model 200 can be pushed toward learning a function that the student model 202 is capable of using such that the teacher model 200 tries to do something that is good for the student model 202. Furthermore, the joint training can enforce discrepancy of the teacher models 200 in the ensemble of N teacher models 200 by using the negative of the distance terms:

Lₜₑ_{₁}(Φ^{(te}^{₁}⁾,Y)+αₜₑ_{₁}Rₜₑ_{₁}+Σᵢ₌₂^{N}γᵢ(Lₜₑ_{ᵢ}(Φ^{(te}^{ᵢ}⁾,Y)+αₜₑ_{ᵢ}Rₜₑ_{ᵢ}( [symbol] ₜₑ))+λ(Lₛₜ(Φ^{(st)},Y)+αₛₜRₛₜ( [symbol] ₛₜ))+Σᵢ₌₁^{N}βᵢD_{F}^{sym}(ψ^{(te}^{ᵢ}⁾,ψ^{(st)})−Σ_{{i,j:i≠j}}θ_{i,j}D_{F}^{sym}(ψ^{(te}^{ᵢ}⁾,ψ^{(te}^{ᵢ}⁾) (7)

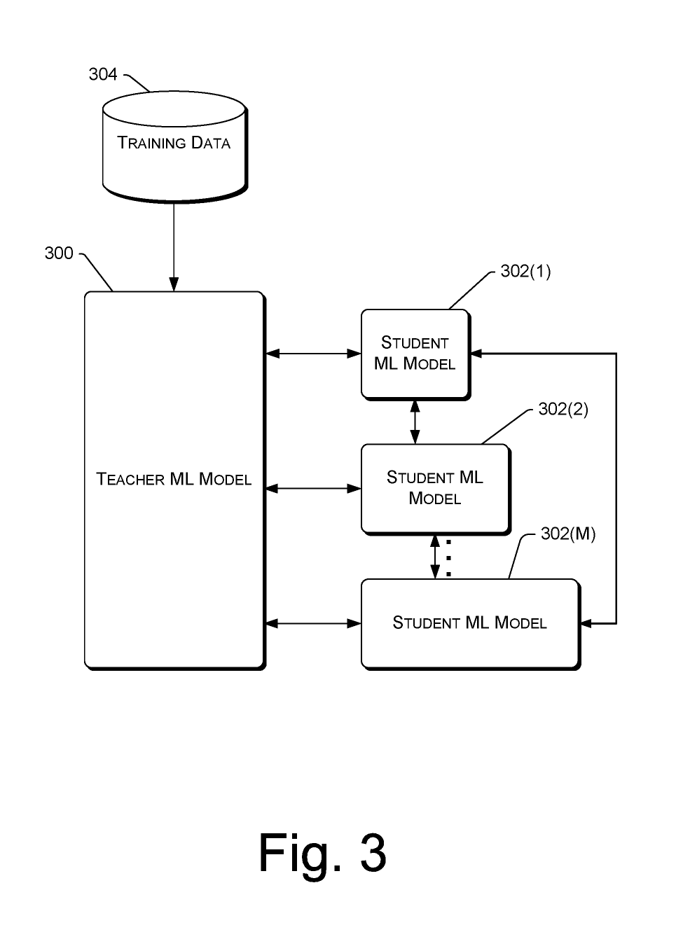

FIG. 3 is a schematic diagram of another example technique for joint training of multiple machine learning models. In the example of FIG. 3, a teacher model 300 can be trained in parallel with M student models 302, shown as student models 302(1), 302(2), . . . , 302(M). In this example, information can be passed (or knowledge can be transferred) between each student model 302 and the teacher model 300 through use of terms in the objective function for the joint training of the machine learning models in the example of FIG. 3. In this sense, each of the student models 302 can influence the training of the teacher model 300, and vice versa, during joint training.

Furthermore, individual pairings of student models 302, such as the student model 302(1) and the student model 302(2) can pass information between each other to learn from each other in parallel. In some implementations, the teacher model 300 can bias toward a learning function that maximizes the number of student models 302 in the set of M student models 302 that are capable of using the learning function chosen by the teacher model 300. In this manner, the teacher model 300 can be pushed, via terms of the objective function, to use a learning function that is good for as many of the students as possible. For example, if two or more of the student models 302 are capable of using a first learning function available to the teacher model 300, and only the student model 302(M) is capable of using a second learning function, but not the first learning function, the teacher model 300 can choose to train itself with the first learning function to benefit a maximum number of the student models 302. FIG. 3 also shows that training data 304 can be used to train one or more of the machine learning models of FIG. 3, such as the teacher model 300. It is to be appreciated that one or more of the student models 302 can also be trained with at least a portion of the training data 304. The M student models 302 can be of the same type and size, or can differ in type (i.e., architecture) and/or size.

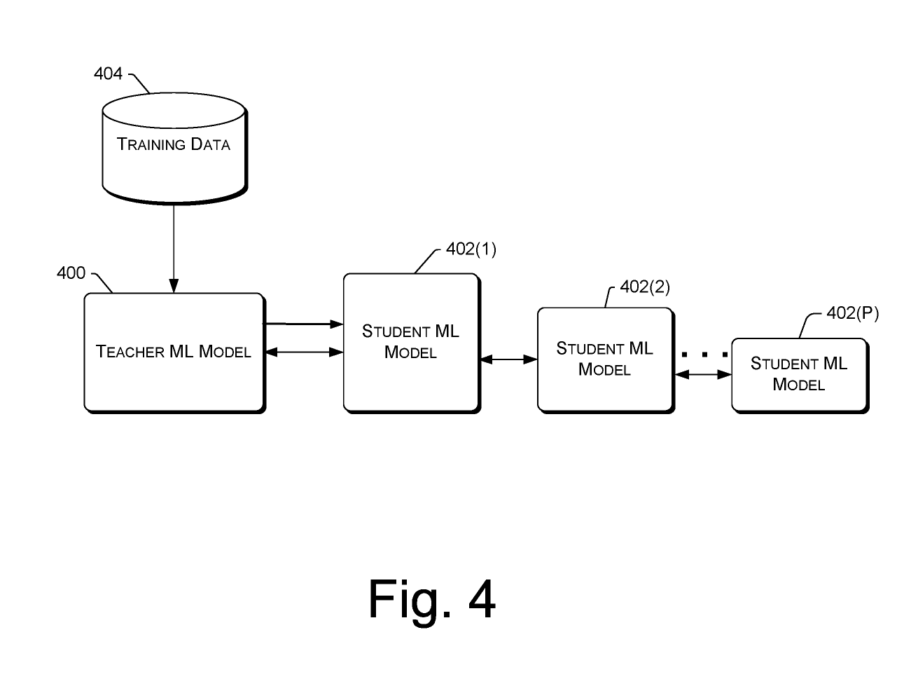

FIG. 4 is a schematic diagram of another example technique for joint training of multiple machine learning models. In the example of FIG. 4, a teacher model 400 can be trained in parallel with P student models 402, shown as student models 402(1), 402(2), . . . , 402(P). In this example, information can be passed (or knowledge can be transferred) between a first student model 402(1) and the teacher model 400, and individual pairings of the student models 402 can pass information between each other, such that the visual depiction of the joint training arrangement looks like the example of FIG. 4 where a series of student models 402 are arranged in a chain, and a first student model 402(1) is able to see how the teacher model 400 learns. Again, the passing of information (or knowledge transfer) between machine learning models is enabled through the use of appropriate terms in the objective function for the joint training of the machine learning models in the example of FIG. 4. In this sense, the teacher model 400 can influence the training of the student model 402(1), and vice versa, during joint training. Furthermore, the student model 402(1) can influence the training of the student model 402(2), and vice versa, and so on down the chain of student models 402.

FIG. 4 also shows that training data 404 can be used to train one or more of the machine learning models of FIG. 4, such as the teacher model 400. FIG. 4 also indicates that the P student models 402 can decrease in size from 402(1) to 402(P) in terms of the amount of memory to store each of the student models 402 in the set of P student models 402. This can be beneficial if the last student model 402(P) in the chain of student models 402 is to be deployed on a mobile device with limited memory and/or processing power, and instead of going straight from a potentially very large teacher model 400 to a single student model 402(P) that is small enough to deploy, as might be the case with the example of FIG. 1, the implementations of FIG. 4 allows for model compression from a relatively large teacher model 400, to a slightly smaller student model 402(1), and then to a slightly smaller student model 402(2), and so on. Eventually, the joint model training results in a trained student model 402(P) that is a compressed form of the teacher model 400, and the student model 402(P) can be deployed on a computing device with limited resources. It is to be appreciated, however, that the machine learning models of FIG. 4 can be of the same, or similar size, while differing in architecture, for example, without departing from the basic nature of the joint training techniques disclosed herein.

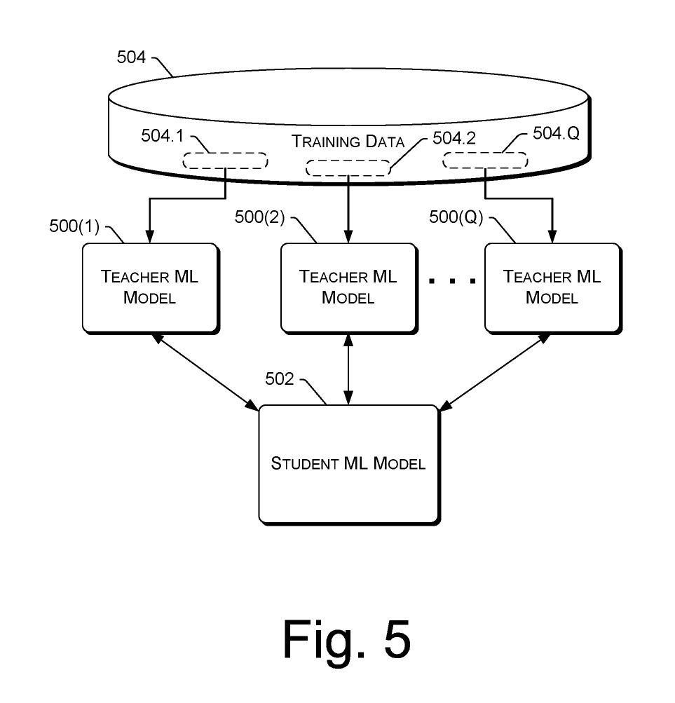

FIG. 5 is a schematic diagram of another example technique for joint training of multiple machine learning models=. In the example of FIG. 5, an ensemble of Q teacher models 500, represented in FIG. 5 as models 500(1), 500(2), . . . , 500(Q) can be trained in parallel with a student model 502. In this sense, each of the teacher models 500 can influence the training of the student model 502, and vice versa, during joint training. The Q teacher models 500 can be of the same type and size, or can differ in type (i.e., architecture) and/or size. In the implementation of FIG. 5, each of the Q teacher models 500 is shown as receiving a respective portion 504.1, 504.2, . . . 504.Q of a large set of training data 504. Each portion 504.1-504.Q can be independent and distinct from any other portion of the training data 504, or, in some implementations, at least some of the portions 504.1-504.Q can have some of the same training data such that the portions overlap, at least in part. For example, a first portion 504.1 of the training data 504 that is provided to the first teacher model 500(1) can include sub-portions A and B, while a second portion 504.2 that is provided to the second teacher model 500(2) can include sub-portions B and C. In this example, the first and second portions 504.1 and 504.2 of the training data 504 include at least some “overlapping” data (i.e., sub-portion B), which is provided to both teacher models 500(1) and 500(2), yet each teacher model 500(1) and 500(2) receives at least some additional training data 504 that differs between the models 500(1) and 500(2). In this example, the training data 504 can be too large for any one machine learning model 500 to handle because the training data 504 can be too large (in terms of storage footprint) to store on any single computing device on which the machine learning models are executed. Accordingly, each of the teacher models 500 in the set of Q teacher models can run on a computing device with respective portion 504.1-504.Q of the training data 504 that can be maintained on the computing device. In this manner, the multiple teacher models 504 can enable a student model 502 to learn from a relatively large set of training data 504 indirectly through the passing of information between the student model 502 and each of the teacher models 500.

It is to be appreciated that in any of the joint training examples described herein, the plurality of machine learning models in a set of machine learning models can be trained in parallel, or, alternatively, individual pairings of machine learning models can be jointly trained in parallel, one after the other, until all of the machine learning models in a set are trained. In other words, a hybrid parallel-sequential training can be implemented in any of the examples where more than two machine learning models are to be jointly trained, so long as at least two of the machine learning models are trained in parallel at any given time.

The processes described herein are illustrated as a collection of blocks in a logical flow graph, which represent a sequence of operations that can be implemented in hardware, software, or a combination thereof. In the context of software, the blocks represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process. Moreover, in some implementations, one or more blocks of the processes can be omitted entirely.

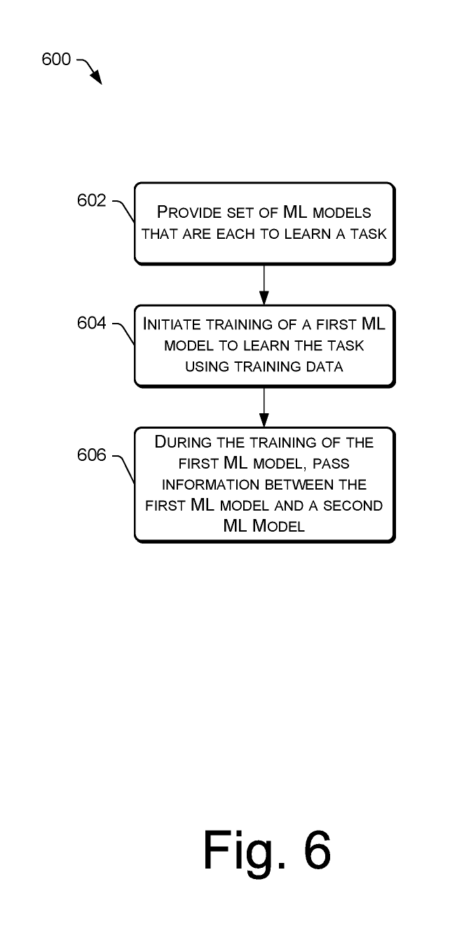

FIG. 6 is a flow diagram of an example process 600 for joint training of multiple machine learning models. For discussion purposes, the process 600 is described with reference to the previous FIGS. 1-5.

At 602, a set of multiple machine learning models, such as the first model 100 and the second model 102 of FIG. 1, can be provided. Each of the machine learning models in the set can be capable of learning a task, such as a classification task (binary or multi-label), a regression task to infer a set of probabilities based on unknown input data, or any other suitable machine learning task.

At 604, training of a first machine learning model (e.g., the first model 100) can be initiated to learn the task using training data 104, as described herein. During training, an optimization problem can be solved by determining parameter values (e.g., values of weight parameters) for each model in the set of models provided at 602 that optimizes (e.g., minimizes) an objective function for joint training of the set of machine learning models.

At 606, during the training of the first machine learning model (e.g., the first model 100), information can be passed between the first machine learning model 100 and a second machine learning model 102. Passing of information at 606 between machine learning models can be enabled through the use of terms in the objective function that is optimized during the joint training. For example, terms such as the penalty term, and/or the classification terms of the objective function can be based on (i.e., a function of) the outputs of one or more of the machine learning models in the set of models provided at 602. In this manner, a model, such as the second model 102, is able to “see” how the first model 100 learns, as the first model 100 is learning, or vice versa. In some implementations, bi-directional passing of information can occur at 606 such that the first model 100 sees what the second model 102 is learning, and the second model 102 sees what the first model 100 is learning.

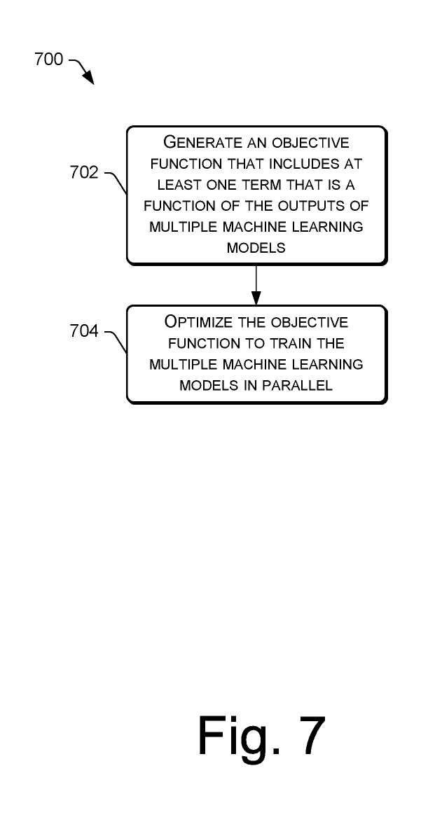

FIG. 7 is a flow diagram of an example process 700 for joint training of multiple machine learning models. For discussion purposes, the process 700 is described with reference to the previous FIGS. 1-5.

At 702, an objective function can be generated that includes at least one term that is a function of a first output of a first machine learning model, such as the first model 100 of FIG. 1, and a second output of a second machine learning model, such as the second model 102 of FIG. 1. An objective function can be generated as having a penalty term (or distance term) that is based on the outputs of the first model 100 and the second model 102. The penalty term can work by optimizing the objective function when the outputs of the models agree, and penalizing the optimization problem when the outputs of the models disagree. In other words, with a minimization problem, the penalty term can increase as the outputs of the two models diverge, and the penalty term can decrease as the outputs of the two models converge to agreement.

At 704, the objective function can be optimized in order to train the multiple machine learning models in parallel. For example, model parameters (e.g., weight parameters) can be determined that optimize (e.g., minimize) the objective function generated at 702. Once trained, the models can be used to generate expected output from unknown input, such as a class label for an unknown image.

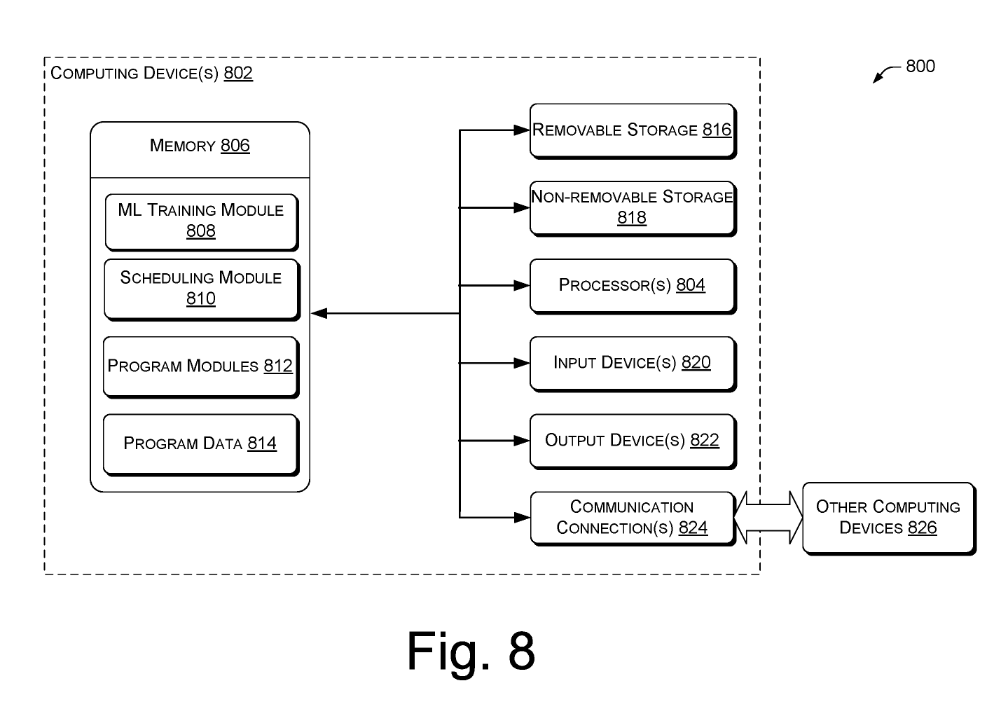

FIG. 8 illustrates an exemplary computing system environment 800 for implementing the joint training techniques and systems described herein. The environment 800 can include a computing device 802, which can represent any suitable computing device, or set of computing devices (e.g., server computers).

In some implementations, the computing device 802 includes one or more processors 804 and computer-readable memory 806. The processor(s) 804 can be configured to execute instructions, applications, or programs stored in the memory 806. In some implementations, the processor(s) 804 can include hardware processors that include, without limitation, a hardware central processing unit (CPU), a field programmable gate array (FPGA), a complex programmable logic device (CPLD), an application specific integrated circuit (ASIC), a system-on-chip (SoC), or a combination thereof. Depending on the exact configuration and type of computing device, the memory 806 can be volatile (e.g., random access memory (RAM)), non-volatile (e.g., read only memory (ROM), flash memory, etc.), or some combination of the two. The memory 806 can include machine learning training module 808, a scheduling module 810, one or more program modules 812 or application programs, and program data 814 accessible to the processor(s) 804.

The machine learning training module 808 can be configured to carry out the operations and techniques described herein for joint training of multiple machine learning models, such as the first model 100 and the second model 102 of FIG. 1. The scheduling module 810 can be configured to implement an efficient training procedure for the machine learning training module 808. For example, with reference to FIG. 1, the scheduling module 810 can initiate training of the second (student) machine learning model 102 at a slow learning rate, and gradually increase the learning rate of the second model 102 as training progresses. In general, a scheduling module 810 can be configured to control the learning rate of any machine learning model for efficiency in computation. Furthermore, the scheduling module 810 can be configured to control the degree to which any given machine learning model can influence another. For example, an allocation between the use of training data and machine learning model output can be specified for a given model's training (e.g., 90% training from training data 104, and 10% training from the output of another machine learning model).

The computing device 802 can also include additional data storage devices (removable and/or non-removable) such as, for example, magnetic disks, optical disks, or tape. Such additional storage is illustrated in FIG. 8 by removable storage 816 and non-removable storage 818. Computer-readable media, as used herein, can include, at least, two types of computer-readable media, namely computer storage media and communication media. Computer storage media can include volatile and nonvolatile, removable and non-removable media implemented in any method or technology for storage of information, such as computer readable instructions, data structures, program modules, or other data. The memory 806, removable storage 816, and non-removable storage 818 are all examples of computer storage media. Computer storage media includes, but is not limited to, RAM, ROM, electrically erasable programmable read-only memory (EEPROM), flash memory or other memory technology, compact disk read-only memory (CD-ROM), digital versatile disks (DVD), or other optical storage, magnetic cassettes, magnetic tape, magnetic disk storage or other magnetic storage devices, or any other non-transmission medium that can be used to store the desired information and which can be accessed by the computing device 802. Any such computer storage media can be part of the device 802.

In some implementations, any or all of the memory 806, removable storage 816, and non-removable storage 818 can store programming instructions, data structures, program modules and other data, which, when executed by the processor(s) 804, implement some or all of the processes described herein.

In contrast, communication media can embody computer-readable instructions, data structures, program modules, or other data in a modulated data signal, such as a carrier wave, or other transmission mechanism. As defined herein, computer storage media does not include communication media.

The computing device 802 can also comprise input device(s) 820 such as a touch screen, keyboard, pointing devices (e.g., mouse, touch pad, joystick, etc.), pen, microphone, etc., through which a user can enter commands and information into the computing device 802. The computing device 802 can also comprise output device(s) 822, such as a display, speakers, a printer, etc.

The computing device 802 can operate in a networked environment and, as such, the computing device 802 can further include communication connections 824 that allow the device to communicate with other computing devices 826, such as over a network, which can include wired and/or wireless networks that enable communications between the various entities in the environment 800. For example, a network(s) enabling communication between the computing device(s) 802 and the other computing devices 826 can include cable networks, the Internet, local area networks (LANs), wide area networks (WAN), mobile telephone networks (MTNs), and other types of networks, possibly used in conjunction with one another.

The environment and individual elements described herein can of course include many other logical, programmatic, and physical components, of which those shown in the accompanying figures are merely examples that are related to the discussion herein.

The various techniques described herein are assumed in the given examples to be implemented in the general context of computer-executable instructions or software, such as program modules, that are stored in computer-readable storage and executed by the processor(s) of one or more computers or other devices such as those illustrated in the figures. Generally, program modules include routines, programs, objects, components, data structures, etc., and define operating logic for performing particular tasks or implement particular abstract data types.

Other architectures can be used to implement the described functionality, and are intended to be within the scope of this disclosure. Furthermore, although specific distributions of responsibilities are defined above for purposes of discussion, the various functions and responsibilities might be distributed and divided in different ways, depending on circumstances.

Similarly, software can be stored and distributed in various ways and using different means, and the particular software storage and execution configurations described above can be varied in many different ways. Thus, software implementing the techniques described above can be distributed on various types of computer-readable media, not limited to the forms of memory that are specifically described.

### Example One

A computer-implemented method comprising: providing a set of machine learning models that are to learn a respective task (e.g., a classification task, such as a binary classification task, a multi-label classification task, or a task that infers a set of probabilities based on unknown input data, etc.), the set of machine learning models including a first machine learning model and a second machine learning model; initiating training of the first machine learning model to learn a first task using training data (e.g., data (e.g., image data, speech data, text data, video data, etc.), features, and, optionally, labels (e.g., class labels, probabilities, etc.)); and during the training of the first machine learning model, passing information between the first machine learning model and the second machine learning model (e.g., formulating an objective function for the set of models so that each model can have access to unlabeled data, and/or the training data, and/or outputs generated by at least one other model in the set of models through one or more terms of the objective function).

### Example Two

The computer-implemented method of Example One, wherein passing the information comprises providing the second machine learning model access to output from the first machine learning model, the method further comprising training the second machine learning model to learn the first task, or a second task that is related to the first task, using the output from the first machine learning model.

### Example Three

The computer-implemented method of any of the previous examples, alone or in combination, wherein the output from the first machine learning model comprises at least one of probability outputs, logits, or unnormalized probabilities.

### Example Four

The computer-implemented method of any of the previous examples, alone or in combination, wherein: the first machine learning model is trained to learn the first task using a set of features from the training data (e.g., an n-dimensional feature vector of quantifiable information about an attribute of the data); and passing the information comprises providing the second machine learning model access to output from the first machine learning model, the method further comprising training the second machine learning model to learn the first task, or a second task that is related to the first task, using the output from the first machine learning model and a subset of features from the set of features.

### Example Five

The computer-implemented method of any of the previous examples, alone or in combination, wherein: the set of machine learning models further includes a plurality of teacher machine learning models; and the first machine learning model is one of the plurality of teacher machine learning models, the method further comprising training the first machine learning model and at least one other teacher machine learning model of the plurality of teacher machine learning models in parallel with each other and in parallel with the second machine learning model.

### Example Six

The computer-implemented method of any of the previous examples, alone or in combination, wherein the first machine learning model is trained from a first portion of the training data and the at least one other teacher machine learning model is trained from a second portion of the training data that is different than the first portion.

### Example Seven

The computer-implemented method of any of the previous examples, alone or in combination, wherein: the set of machine learning models further includes a plurality of student machine learning models; and the second machine learning model is one of the plurality of student machine learning models, the method further comprising training the second machine learning model and at least one other student machine learning model of the plurality of student machine learning models in parallel with each other and in parallel with the first machine learning model.

### Example Eight

The computer-implemented method of any of the previous examples, alone or in combination, further comprising passing information between individual pairings of the plurality of student machine learning models during the training of the first machine learning model and during the training of at least some of the plurality of student machine learning models.

### Example Nine

The computer-implemented method of any of the previous examples, alone or in combination, wherein the second machine learning model is trained and stored as a trained second machine learning model in a smaller amount of memory than an amount of memory to store the first machine learning model after the first machine learning model is trained.

### Example Ten

A system comprising: one or more processors (e.g., central processing units (CPUs), field programmable gate array (FPGAs), complex programmable logic devices (CPLDs), application specific integrated circuits (ASICs), system-on-chips (SoCs), etc.); and memory (e.g., RAM, ROM, EEPROM, flash memory, etc.) storing computer-executable instructions that, when executed by the one or more processors, cause performance of operations comprising: providing a set of machine learning models that are to learn a respective task (e.g., a classification task, such as a binary classification task, a multi-label classification task, or a task that infers a set of probabilities based on unknown input data, etc.), the set of machine learning models including a first machine learning model and a second machine learning model; initiating training of the first machine learning model to learn a first task using training data (e.g., data (e.g., image data, speech data, text data, video data, etc.), features, and, optionally, labels (e.g., class labels, probabilities, etc.)); and during the training of the first machine learning model, passing information between the first machine learning model and the second machine learning model (e.g., formulating an objective function for the set of models so that each model can have access to unlabeled data, and/or the training data, and/or outputs generated by at least one other model in the set of models through one or more terms of the objective function).

### Example Eleven

The system of Example Ten, wherein passing the information comprises providing the second machine learning model access to output from the first machine learning model, the operations further comprising training the second machine learning model to learn the first task, or a second task that is related to the first task, using the output from the first machine learning model.

### Example Twelve

The system of any of the previous examples, alone or in combination, wherein the output from the first machine learning model comprises at least one of probability outputs, logits, or unnormalized probabilities.

### Example Thirteen

The system of any of the previous examples, alone or in combination, wherein: the first machine learning model is trained to learn the first task using a set of features from the training data (e.g., an n-dimensional feature vector of quantifiable information about an attribute of the data); and passing the information comprises providing the second machine learning model access to output from the first machine learning model, the operations further comprising training the second machine learning model to learn the first task, or a second task that is related to the first task, using the output from the first machine learning model and a subset of features from the set of features.

### Example Fourteen

The system of any of the previous examples, alone or in combination, wherein: the set of machine learning models further includes a plurality of teacher machine learning models; and the first machine learning model is one of the plurality of teacher machine learning models, the operations further comprising training the first machine learning model and at least one other teacher machine learning model of the plurality of teacher machine learning models in parallel with each other and in parallel with the second machine learning model.

### Example Fifteen

The system of any of the previous examples, alone or in combination, wherein the first machine learning model is trained from a first portion of the training data and the at least one other teacher machine learning model is trained from a second portion of the training data that is different than the first portion.

### Example Sixteen

The system of any of the previous examples, alone or in combination, wherein: the set of machine learning models further includes a plurality of student machine learning models; and the second machine learning model is one of the plurality of student machine learning models, the operations further comprising training the second machine learning model and at least one other student machine learning model of the plurality of student machine learning models in parallel with each other and in parallel with the first machine learning model.

### Example Seventeen

The system of any of the previous examples, alone or in combination, the operations further comprising passing information between individual pairings of the plurality of student machine learning models during the training of the first machine learning model and during the training of at least some of the plurality of student machine learning models.

### Example Eighteen

The system of any of the previous examples, alone or in combination, wherein the second machine learning model is trained and stored as a trained second machine learning model in a smaller amount of memory than an amount of memory to store the first machine learning model after the first machine learning model is trained.

### Example Nineteen

One or more computer-readable storage media (e.g., RAM, ROM, EEPROM, flash memory, etc.) storing computer-executable instructions that, when executed by a processor (e.g., central processing unit (CPU), a field programmable gate array (FPGA), a complex programmable logic device (CPLD), an application specific integrated circuit (ASIC), a system-on-chip (SoC), etc.), perform operations comprising: providing a set of machine learning models that are to learn a respective task (e.g., a classification task, such as a binary classification task, a multi-label classification task, or a task that infers a set of probabilities based on unknown input data, etc.), the set of machine learning models including a first machine learning model and a second machine learning model; initiating training of the first machine learning model to learn a first task using training data (e.g., data (e.g., image data, speech data, text data, video data, etc.), features, and, optionally, labels (e.g., class labels, probabilities, etc.)); and during the training of the first machine learning model, passing information between the first machine learning model and the second machine learning model (e.g., formulating an objective function for the set of models so that each model can have access to unlabeled data, and/or the training data, and/or outputs generated by at least one other model in the set of models through one or more terms of the objective function).

### Example Twenty

The one or more computer-readable storage media of Example Nineteen, wherein passing the information comprises providing the second machine learning model access to output from the first machine learning model, the operations further comprising training the second machine learning model to learn the first task, or a second task that is related to the first task, using the output from the first machine learning model.

### Example Twenty-One

The one or more computer-readable storage media of any of the previous examples, alone or in combination, wherein the output from the first machine learning model comprises at least one of probability outputs, logits, or unnormalized probabilities.

### Example Twenty-Two

The one or more computer-readable storage media of any of the previous examples, alone or in combination, wherein: the first machine learning model is trained to learn the first task using a set of features from the training data (e.g., an n-dimensional feature vector of quantifiable information about an attribute of the data); and passing the information comprises providing the second machine learning model access to output from the first machine learning model, the operations further comprising training the second machine learning model to learn the first task, or a second task that is related to the first task, using the output from the first machine learning model and a subset of features from the set of features.

### Example Twenty-Three

The one or more computer-readable storage media of any of the previous examples, alone or in combination, wherein: the set of machine learning models further includes a plurality of teacher machine learning models; and the first machine learning model is one of the plurality of teacher machine learning models, the operations further comprising training the first machine learning model and at least one other teacher machine learning model of the plurality of teacher machine learning models in parallel with each other and in parallel with the second machine learning model.

### Example Twenty-Four

The one or more computer-readable storage media of any of the previous examples, alone or in combination, wherein the first machine learning model is trained from a first portion of the training data and the at least one other teacher machine learning model is trained from a second portion of the training data that is different than the first portion.

### Example Twenty-Five

The one or more computer-readable storage media of any of the previous examples, alone or in combination, wherein: the set of machine learning models further includes a plurality of student machine learning models; and the second machine learning model is one of the plurality of student machine learning models, the operations further comprising training the second machine learning model and at least one other student machine learning model of the plurality of student machine learning models in parallel with each other and in parallel with the first machine learning model.

### Example Twenty-Six

The one or more computer-readable storage media of any of the previous examples, alone or in combination, the operations further comprising passing information between individual pairings of the plurality of student machine learning models during the training of the first machine learning model and during the training of at least some of the plurality of student machine learning models.

### Example Twenty-Seven

The one or more computer-readable storage media of any of the previous examples, alone or in combination, wherein the second machine learning model is trained and stored as a trained second machine learning model in a smaller amount of memory than an amount of memory to store the first machine learning model after the first machine learning model is trained.

### Example Twenty-Eight

A computer-implemented method comprising: initiating training of a first machine learning model to learn a first task (e.g., a classification task, such as a binary classification task, a multi-label classification task, or a task that infers a set of probabilities based on unknown input data, etc.) using training data (e.g., data (e.g., image data, speech data, text data, video data, etc.), features, and, optionally, labels (e.g., class labels, probabilities, etc.)); and during the training of the first machine learning model: initiating training of a second machine learning model to learn the first task or a second task that is related to the first task; and passing information between the first machine learning model and the second machine learning model (e.g., formulating an objective function for the set of models so that each model can have access to unlabeled data, and/or the training data, and/or outputs generated by at least one other model through one or more terms of the objective function).

### Example Twenty-Nine

The computer-implemented method of Example Twenty-Eight, wherein: the first machine learning model is trained to learn the first task using a set of features from the training data (e.g., an n-dimensional feature vector of quantifiable information about an attribute of the data); and passing the information comprises providing the second machine learning model access to output from the first machine learning model, the method further comprising training the second machine learning model to learn the first task or the second task using the output from the first machine learning model and a subset of features from the set of features.

### Example Thirty

The computer-implemented method of any of the previous examples, alone or in combination, wherein the output from the first machine learning model is based on processing unlabeled input data through the first machine learning model.

### Example Thirty-One

The computer-implemented method of any of the previous examples, alone or in combination, wherein the first machine learning model is one of a plurality of teacher machine learning models in a set of machine learning models that includes the plurality of teacher machine learning models and the second machine learning model, the method further comprising training the first machine learning model and at least one other teacher machine learning model of the plurality of teacher machine learning models in parallel with each other and in parallel with the second machine learning model.

### Example Thirty-Two

The computer-implemented method of any of the previous examples, alone or in combination, wherein the second machine learning model is one of a plurality of student machine learning models in a set of machine learning models that includes the plurality of student machine learning models and the first machine learning model, the method further comprising training the second machine learning model and at least one other student machine learning model of the plurality of student machine learning models in parallel with each other and in parallel with the first machine learning model.

### Example Thirty-Three

The computer-implemented method of any of the previous examples, alone or in combination, wherein the second machine learning model is trained and stored in a larger amount of memory than an amount of memory to store the at least one other student machine learning model.

### Example Thirty-Four

A system comprising: one or more processors (e.g., central processing units (CPUs), field programmable gate array (FPGAs), complex programmable logic devices (CPLDs), application specific integrated circuits (ASICs), system-on-chips (SoCs), etc.); and memory (e.g., RAM, ROM, EEPROM, flash memory, etc.) storing computer-executable instructions that, when executed by the one or more processors, cause performance of operations comprising: initiating training of a first machine learning model to learn a first task (e.g., a classification task, such as a binary classification task, a multi-label classification task, or a task that infers a set of probabilities based on unknown input data, etc.) using training data (e.g., data (e.g., image data, speech data, text data, video data, etc.), features, and, optionally, labels (e.g., class labels, probabilities, etc.)); and during the training of the first machine learning model: initiating training of a second machine learning model to learn the first task or a second task that is related to the first task; and passing information between the first machine learning model and the second machine learning model (e.g., formulating an objective function for the set of models so that each model can have access to unlabeled data, and/or the training data, and/or outputs generated by at least one other model through one or more terms of the objective function).

### Example Thirty-Five

The system of Example Thirty-Four, wherein: the first machine learning model is trained to learn the first task using a set of features from the training data (e.g., an n-dimensional feature vector of quantifiable information about an attribute of the data); and passing the information comprises providing the second machine learning model access to output from the first machine learning model, the operations further comprising training the second machine learning model to learn the first task or the second task using the output from the first machine learning model and a subset of features from the set of features.

### Example Thirty-Six

The system of any of the previous examples, alone or in combination, wherein the output from the first machine learning model is based on processing unlabeled input data through the first machine learning model.

### Example Thirty-Seven

The system of any of the previous examples, alone or in combination, wherein the first machine learning model is one of a plurality of teacher machine learning models in a set of machine learning models that includes the plurality of teacher machine learning models and the second machine learning model, the operations further comprising training the first machine learning model and at least one other teacher machine learning model of the plurality of teacher machine learning models in parallel with each other and in parallel with the second machine learning model.

### Example Thirty-Eight

The system of any of the previous examples, alone or in combination, wherein the second machine learning model is one of a plurality of student machine learning models in a set of machine learning models that includes the plurality of student machine learning models and the first machine learning model, the operations further comprising training the second machine learning model and at least one other student machine learning model of the plurality of student machine learning models in parallel with each other and in parallel with the first machine learning model.

### Example Thirty-Nine

The system of any of the previous examples, alone or in combination, wherein the second machine learning model is trained and stored in a larger amount of memory than an amount of memory to store the at least one other student machine learning model.

### Example Forty

One or more computer-readable storage media (e.g., RAM, ROM, EEPROM, flash memory, etc.) storing computer-executable instructions that, when executed by a processor (e.g., central processing unit (CPU), a field programmable gate array (FPGA), a complex programmable logic device (CPLD), an application specific integrated circuit (ASIC), a system-on-chip (SoC), etc.), perform operations comprising: initiating training of a first machine learning model to learn a first task (e.g., a classification task, such as a binary classification task, a multi-label classification task, or a task that infers a set of probabilities based on unknown input data, etc.) using training data (e.g., data (e.g., image data, speech data, text data, video data, etc.), features, and, optionally, labels (e.g., class labels, probabilities, etc.)); and during the training of the first machine learning model: initiating training of a second machine learning model to learn the first task or a second task that is related to the first task; and passing information between the first machine learning model and the second machine learning model (e.g., formulating an objective function for the set of models so that each model can have access to unlabeled data, and/or the training data, and/or outputs generated by at least one other model through one or more terms of the objective function).

### Example Forty-One

The one or more computer-readable storage media of Example Forty, wherein: the first machine learning model is trained to learn the first task using a set of features from the training data (e.g., an n-dimensional feature vector of quantifiable information about an attribute of the data); and passing the information comprises providing the second machine learning model access to output from the first machine learning model, the operations further comprising training the second machine learning model to learn the first task or the second task using the output from the first machine learning model and a subset of features from the set of features.

### Example Forty-Two

The one or more computer-readable storage media of any of the previous examples, alone or in combination, wherein the output from the first machine learning model is based on processing unlabeled input data through the first machine learning model.

### Example Forty-Three

The one or more computer-readable storage media of any of the previous examples, alone or in combination, wherein the first machine learning model is one of a plurality of teacher machine learning models in a set of machine learning models that includes the plurality of teacher machine learning models and the second machine learning model, the operations further comprising training the first machine learning model and at least one other teacher machine learning model of the plurality of teacher machine learning models in parallel with each other and in parallel with the second machine learning model.

### Example Forty-Four

The one or more computer-readable storage media of any of the previous examples, alone or in combination, wherein the second machine learning model is one of a plurality of student machine learning models in a set of machine learning models that includes the plurality of student machine learning models and the first machine learning model, the operations further comprising training the second machine learning model and at least one other student machine learning model of the plurality of student machine learning models in parallel with each other and in parallel with the first machine learning model.

### Example Forty-Five

The one or more computer-readable storage media of any of the previous examples, alone or in combination, wherein the second machine learning model is trained and stored in a larger amount of memory than an amount of memory to store the at least one other student machine learning model.

### Example Forty-Six

A computer-implemented method for training a set of machine learning models, the method comprising: generating an objective function that includes at least one term that is a function of a first output of a first machine learning model and second output of a second machine learning model; and optimizing the objective function (e.g., by determining parameter values, such as weight parameter values, for the set of machine learning models that optimizes (e.g., minimizes) the objective function) to train the first machine learning model and the second machine learning model.

### Example Forty-Seven

The computer-implemented method of Example Forty-Six, wherein the first output comprises at least one of probability outputs, logits, or unnormalized probabilities.

### Example Forty-Eight

The computer-implemented method of any of the previous examples, alone or in combination, wherein the first machine learning model is to learn a first task (e.g., a classification task, such as a binary classification task, a multi-label classification task, or a task that infers a set of probabilities based on unknown input data, etc.), and the second machine learning model is to learn the first task, or a second task that is related to the first task.

### Example Forty-Nine

The computer-implemented method of any of the previous examples, alone or in combination, wherein: the set of machine learning models further includes a plurality of teacher machine learning models, the plurality of teacher machine learning models including: the first machine learning model; and a third machine learning model; the at least one term included in the objective function is further a function of a third output of the third machine learning model; and optimizing the objective function trains the first machine learning model and third machine learning model in parallel with each other and in parallel with the second machine learning model.

### Example Fifty

The computer-implemented method of any of the previous examples, alone or in combination, wherein the first machine learning model is trained from a first portion of training data and the third machine learning model is trained from a second portion of the training data that is different than the first portion.

### Example Fifty-One

A system comprising: one or more processors (e.g., central processing units (CPUs), field programmable gate array (FPGAs), complex programmable logic devices (CPLDs), application specific integrated circuits (ASICs), system-on-chips (SoCs), etc.); and memory (e.g., RAM, ROM, EEPROM, flash memory, etc.) storing computer-executable instructions that, when executed by the one or more processors, cause performance of operations for training a set of machine learning models, the operations comprising: generating an objective function that includes at least one term that is a function of a first output of a first machine learning model and second output of a second machine learning model; and optimizing the objective function (e.g., by determining parameter values, such as weight parameter values, for the set of machine learning models that optimizes (e.g., minimizes) the objective function) to train the first machine learning model and the second machine learning model.

### Example Fifty-Two

The system of Example Fifty-One, wherein the first output comprises at least one of probability outputs, logits, or unnormalized probabilities.

### Example Fifty-Three

The system of any of the previous examples, alone or in combination, wherein the first machine learning model is to learn a first task (e.g., a classification task, such as a binary classification task, a multi-label classification task, or a task that infers a set of probabilities based on unknown input data, etc.), and the second machine learning model is to learn the first task, or a second task that is related to the first task.

### Example Fifty-Four

The system of any of the previous examples, alone or in combination, wherein: the set of machine learning models further includes a plurality of teacher machine learning models, the plurality of teacher machine learning models including: the first machine learning model; and a third machine learning model; the at least one term included in the objective function is further a function of a third output of the third machine learning model; and optimizing the objective function trains the first machine learning model and third machine learning model in parallel with each other and in parallel with the second machine learning model.

### Example Fifty-Five

The system of any of the previous examples, alone or in combination, wherein the first machine learning model is trained from a first portion of training data and the third machine learning model is trained from a second portion of the training data that is different than the first portion.

### Example Fifty-Six

One or more computer-readable storage media (e.g., RAM, ROM, EEPROM, flash memory, etc.) storing computer-executable instructions that, when executed by a processor (e.g., central processing unit (CPU), a field programmable gate array (FPGA), a complex programmable logic device (CPLD), an application specific integrated circuit (ASIC), a system-on-chip (SoC), etc.), perform operations for training a set of machine learning models, the operations comprising: generating an objective function that includes at least one term that is a function of a first output of a first machine learning model and second output of a second machine learning model; and optimizing the objective function (e.g., by determining parameter values, such as weight parameter values, for the set of machine learning models that optimizes (e.g., minimizes) the objective function) to train the first machine learning model and the second machine learning model.

### Example Fifty-Seven

The one or more computer-readable storage media of Example Fifty-Six, wherein the first output comprises at least one of probability outputs, logits, or unnormalized probabilities.

### Example Fifty-Eight

The one or more computer-readable storage media of any of the previous examples, alone or in combination, wherein the first machine learning model is to learn a first task (e.g., a classification task, such as a binary classification task, a multi-label classification task, or a task that infers a set of probabilities based on unknown input data, etc.), and the second machine learning model is to learn the first task, or a second task that is related to the first task.

### Example Fifty-Nine

The one or more computer-readable storage media of any of the previous examples, alone or in combination, wherein: the set of machine learning models further includes a plurality of teacher machine learning models, the plurality of teacher machine learning models including: the first machine learning model; and a third machine learning model; the at least one term included in the objective function is further a function of a third output of the third machine learning model; and optimizing the objective function trains the first machine learning model and third machine learning model in parallel with each other and in parallel with the second machine learning model.

### Example Sixty

The one or more computer-readable storage media of any of the previous examples, alone or in combination, wherein the first machine learning model is trained from a first portion of training data and the third machine learning model is trained from a second portion of the training data that is different than the first portion.

### Example Sixty-One

A system comprising: means for executing computer-executable instructions (e.g., central processing unit (CPU), a field programmable gate array (FPGA), a complex programmable logic device (CPLD), an application specific integrated circuit (ASIC), a system-on-chip (SoC), etc.); and means for storing (e.g., RAM, ROM, EEPROM, flash memory, etc.) instructions that, when executed by the means for executing computer-executable instructions, perform operations comprising: providing a set of machine learning models that are to learn a respective task (e.g., a classification task, such as a binary classification task, a multi-label classification task, or a task that infers a set of probabilities based on unknown input data, etc.), the set of machine learning models including a first machine learning model and a second machine learning model; initiating training of the first machine learning model to learn a first task using training data (e.g., data (e.g., image data, speech data, text data, video data, etc.), features, and, optionally, labels (e.g., class labels, probabilities, etc.)); and during the training of the first machine learning model, passing information between the first machine learning model and the second machine learning model (e.g., formulating an objective function for the set of models so that each model can have access to unlabeled data, and/or the training data, and/or outputs generated by at least one other model in the set of models through one or more terms of the objective function).

### Example Sixty-Two

A system comprising: means for executing computer-executable instructions (e.g., central processing unit (CPU), a field programmable gate array (FPGA), a complex programmable logic device (CPLD), an application specific integrated circuit (ASIC), a system-on-chip (SoC), etc.); and means for storing (e.g., RAM, ROM, EEPROM, flash memory, etc.) instructions that, when executed by the means for executing computer-executable instructions, perform operations comprising: initiating training of a first machine learning model to learn a first task (e.g., a classification task, such as a binary classification task, a multi-label classification task, or a task that infers a set of probabilities based on unknown input data, etc.) using training data (e.g., data (e.g., image data, speech data, text data, video data, etc.), features, and, optionally, labels (e.g., class labels, probabilities, etc.)); and during the training of the first machine learning model: initiating training of a second machine learning model to learn the first task or a second task that is related to the first task; and passing information between the first machine learning model and the second machine learning model (e.g., formulating an objective function for the set of models so that each model can have access to unlabeled data, and/or the training data, and/or outputs generated by at least one other model through one or more terms of the objective function).

### Example Sixty-Three

A system comprising: means for executing computer-executable instructions (e.g., central processing unit (CPU), a field programmable gate array (FPGA), a complex programmable logic device (CPLD), an application specific integrated circuit (ASIC), a system-on-chip (SoC), etc.); and means for storing (e.g., RAM, ROM, EEPROM, flash memory, etc.) instructions that, when executed by the means for executing computer-executable instructions, perform operations for training a set of machine learning models, the operations comprising: generating an objective function that includes at least one term that is a function of a first output of a first machine learning model and second output of a second machine learning model; and optimizing the objective function (e.g., by determining parameter values, such as weight parameter values, for the set of machine learning models that optimizes (e.g., minimizes) the objective function) to train the first machine learning model and the second machine learning model.

### Example Sixty-Four

The computer-implemented method of any of the previous examples, alone or in combination, wherein the training data comprises labeled training data.

### Example Sixty-Five

Computer-implemented method of any of the previous examples, alone or in combination, further comprising: training the second machine learning model in parallel with the first machine learning model to develop a trained second machine learning model that is configured to approximate a function learned by the first machine learning model; receiving new, unlabeled data at the trained second machine learning model; and generating output with the trained second machine learning model based on the new, unlabeled data.

In closing, although the various implementations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

What is claimed is:

1. A computer-implemented method comprising:
providing a set of machine learning models that are to learn a respective task, the set of machine learning models including a first machine learning model and a second machine learning model;
initiating training of the first machine learning model to learn a first task using training data; and
during the training of the first machine learning model, passing information between the first machine learning model and the second machine learning model.

2. The computer-implemented method of claim 1, wherein passing the information comprises providing the second machine learning model access to output from the first machine learning model, the method further comprising training the second machine learning model to learn the first task, or a second task that is related to the first task, using the output from the first machine learning model.

3. The computer-implemented method of claim 2, wherein the output from the first machine learning model comprises at least one of probability outputs, logits, or unnormalized probabilities.

4. The computer-implemented method of claim 1, wherein:
the first machine learning model is trained to learn the first task using a set of features from the training data; and
passing the information comprises providing the second machine learning model access to output from the first machine learning model, the method further comprising training the second machine learning model to learn the first task, or a second task that is related to the first task, using the output from the first machine learning model and a subset of features from the set of features.

5. The computer-implemented method of claim 1, wherein:
the set of machine learning models further includes a plurality of teacher machine learning models; and
the first machine learning model is one of the plurality of teacher machine learning models, the method further comprising training the first machine learning model and at least one other teacher machine learning model of the plurality of teacher machine learning models in parallel with each other and in parallel with the second machine learning model.

6. The computer-implemented method of claim 5, wherein the first machine learning model is trained from a first portion of the training data and the at least one other teacher machine learning model is trained from a second portion of the training data that is different than the first portion.

7. The computer-implemented method of claim 1, wherein:
the set of machine learning models further includes a plurality of student machine learning models; and
the second machine learning model is one of the plurality of student machine learning models, the method further comprising training the second machine learning model and at least one other student machine learning model of the plurality of student machine learning models in parallel with each other and in parallel with the first machine learning model.

8. The computer-implemented method of claim 7, further comprising passing information between individual pairings of the plurality of student machine learning models during the training of the first machine learning model and during the training of at least some of the plurality of student machine learning models.

9. The computer-implemented method of claim 1, wherein the second machine learning model is trained and stored as a trained second machine learning model in a smaller amount of memory than an amount of memory to store the first machine learning model after the first machine learning model is trained.

10. A system comprising:
one or more processors; and
memory storing computer-executable instructions that, when executed by the one or more processors, cause performance of operations comprising:
initiating training of a first machine learning model to learn a first task using training data; and
during the training of the first machine learning model:
initiating training of a second machine learning model to learn the first task or a second task that is related to the first task; and
passing information between the first machine learning model and the second machine learning model.

11. The system of claim 10, wherein:
the first machine learning model is trained to learn the first task using a set of features from the training data; and
passing the information comprises providing the second machine learning model access to output from the first machine learning model, the operations further comprising training the second machine learning model to learn the first task or the second task using the output from the first machine learning model and a subset of features from the set of features.

12. The system of claim 11, wherein the output from the first machine learning model is based on processing unlabeled input data through the first machine learning model.

13. The system of claim 10, wherein the first machine learning model is one of a plurality of teacher machine learning models in a set of machine learning models that includes the plurality of teacher machine learning models and the second machine learning model, the operations further comprising training the first machine learning model and at least one other teacher machine learning model of the plurality of teacher machine learning models in parallel with each other and in parallel with the second machine learning model.

14. The system of claim 10, wherein the second machine learning model is one of a plurality of student machine learning models in a set of machine learning models that includes the plurality of student machine learning models and the first machine learning model, the operations further comprising training the second machine learning model and at least one other student machine learning model of the plurality of student machine learning models in parallel with each other and in parallel with the first machine learning model.

15. The system of claim 14, wherein the second machine learning model is trained and stored in a larger amount of memory than an amount of memory to store the at least one other student machine learning model.

16. A computer-implemented method for training a set of machine learning models, the method comprising:
generating an objective function that includes at least one term that is a function of a first output of a first machine learning model and second output of a second machine learning model; and
optimizing the objective function to train the first machine learning model and the second machine learning model.

17. The computer-implemented method of claim 16, wherein the first output comprises at least one of probability outputs, logits, or unnormalized probabilities.

18. The computer-implemented method of claim 16, wherein the first machine learning model is to learn a first task, and the second machine learning model is to learn the first task, or a second task that is related to the first task.

19. The computer-implemented method of claim 16, wherein:
the set of machine learning models further includes a plurality of teacher machine learning models, the plurality of teacher machine learning models including:
the first machine learning model; and
a third machine learning model;
the at least one term included in the objective function is further a function of a third output of the third machine learning model; and
optimizing the objective function trains the first machine learning model and third machine learning model in parallel with each other and in parallel with the second machine learning model.

20. The computer-implemented method of claim 19, wherein the first machine learning model is trained from a first portion of training data and the third machine learning model is trained from a second portion of the training data that is different than the first portion.
